(19) United States
(12) Patent Application Publication
(10) Pub. No.: US 2024/0182725 A1
(43) Pub. Date: Jun. 6, 2024

(54) MULTIDISPERSANT METAL OXIDE NANOPARTICLE DISPERSION COMPOSITIONS

(71) Applicant: 3M INNOVATIVE PROPERTIES COMPANY, St. Paul, MN (US)

(72) Inventors: Jung-Sheng Wu, Woodbury, MN (US); Neeraj Sharma, Lake Elmo, MN (US); Gregory F. King, Minneapolis, MN (US); Christopher A. Haak, Pine Springs, MN (US); Raghunath Padiyath, Woodbury, MN (US)

(21) Appl. No.: 18/554,013

(22) PCT Filed: Mar. 31, 2022
(86) PCT No.: PCT/IB2022/053019

§ 371 Date: Oct. 5, 2023

Related U.S. Application Data
(60) Provisional application No. 63/172,160, filed on Apr. 8, 2021.

(51) Int. Cl. C09D 7/45; C09D 4/06; C09D 7/20; C09D 7/40; C09D 7/61; C09D 7/63; C09D 7/65; C09D 7/80; C09D 17/00; C09D 135/02

(52) U.S. Cl. CPC C09D 7/45; C09D 4/06; C09D 7/20; C09D 7/61; C09D 7/63; C09D 7/65; C09D 7/68; C09D 7/80; C09D 17/002; C09D 17/007; C09D 135/02

(57) ABSTRACT

A composition includes a plurality of pigment particles including a metal oxide, a polymeric first dispersant, and a second dispersant including molecules having a lower molecular weight than the first dispersant. The composition may be used in a hardcoat.

The present technology is generally related to metal oxide dispersions and particularly to metal oxide dispersions stabilized in polymer matrices.

### SUMMARY

Polymeric dispersants may be used to stabilize metal oxide dispersions but excess levels may detrimentally impact haze, as well as other properties such as abrasion resistance, weatherability, and formulation viscosity in polymer matrices made using these dispersions. Techniques of the present disclosure allow the use of low polymeric dispersant levels to stabilize metal oxide dispersions in polymer matrices. In some aspects, these techniques combine a polymeric dispersant and low molecular weight dispersant to optimize surface stabilization and coverage of tungsten oxide nanoparticle dispersions.

In one aspect, the present disclosure provides a composition including a plurality of pigment particles including a metal oxide, a polymeric first dispersant including molecules having an average molecular weight greater than or equal to 2000 atomic mass units; and a second dispersant including molecules having a maximum molecular weight less than 2000 atomic mass units.

In another aspect, the present disclosure provides a hardcoat including a composition according to the present disclosure.

In yet another aspect, the present disclosure provides a method of making a pigment dispersion. The method includes dissolving a polymeric first dispersant and a second dispersant in a solvent to form a solution. The first dispersant includes molecules having an average molecular weight greater than or equal to 2000 atomic mass units, and the second dispersant includes molecules having a maximum molecular weight less than 2000 atomic mass units. The method also includes mixing a plurality of pigment particles including a metal oxide into the solution to form a dispersion and milling the dispersion to a desired particle size.

In still a further aspect, the present disclosure provides a method of making a hardcoat with pigment particles. The method includes dissolving a curable binder material in a solvent to form a solution, adding the solution to a dispersion including a composition according to the present disclosure, adding one or more additives to the dispersion, coating the dispersion onto a substrate, drying the coating to remove the solvent, and curing the dried coating.

### BRIEF DESCRIPTION OF DRAWINGS

FIG. 1 is a conceptual diagram that illustrates a dispersed pigment particle according to the present disclosure.

### DETAILED DESCRIPTION

Techniques of the present disclosure allow the use of low polymeric dispersant levels to stabilize metal oxide dispersions in polymer matrices. In some aspects, these techniques combine a polymeric dispersant and a low molecular weight dispersant to optimize surface stabilization and coverage of tungsten oxide nanoparticle dispersions.

In general, surface stabilizers may be used to stabilize metal oxide surfaces and provide dispersibility in a solvent, especially in an organic system, for example, due to the metal oxide surfaces being hydrophilic. Smaller particles have higher total surface area relative to using larger particles, so more surface stabilizers may be used to sufficiently cover the particle surfaces.

Particularly high levels of dispersants may be used with certain types of metal oxides depending on surface charge and number of hydroxy groups. In one example, tungsten oxide materials may be used with a relatively higher loading of dispersants than other metal oxides due to having a low surface charge and low number of hydroxy groups. In some known and commercially available dispersions, the dispersant used may have 2 to 10 times the total weight of a metal oxide nanoparticle in the dispersion. In these existing dispersions, the amount of dispersant used may be described as an excess amount, which may drive the equilibrium to cover metal oxide surfaces, particularly for tungsten oxide nanoparticles. Some dispersants used with metal oxides include polymeric dispersants with a basic anchoring group, such as an amine, to stabilize acidic particles. The composition of the present disclosure generally provides a relatively lower total weight of dispersant relative to the weight of the metal oxide nanoparticles compared to existing techniques of making dispersions, which may improve coating performance.

A composition of the present disclosure may include a plurality of pigment particles, a first dispersant, and a second dispersant. The second dispersant may have a lower molecular weight than the first dispersant in terms of a maximum molecular weight or an average molecular weight. In some embodiments, the first dispersant has an average or minimum molecular weight greater than or equal to a first threshold value. In some embodiments, the second dispersant has an average or maximum molecular weight less than or equal to a second threshold value. The plurality of pigment particles may include a metal oxide. In some embodiments, the first dispersant is a polymeric dispersant, which may have a high molecular weight. In some embodiments, the second dispersant is a nonpolymeric dispersant. In one example, a composition includes: a plurality of pigment particles including a metal oxide, a polymeric first dispersant including molecules having an average molecular weight greater than or equal to 2000 atomic mass units (amus), and a second dispersant including molecules having a maximum molecular weight less than 2000 amus.

Use of a first dispersant and a second dispersant with the pigment particles may allow for a reduced total dispersant usage compared to existing compositions that use only one dispersant, especially existing compositions using a high molecular weight polymeric dispersant. The reduced total dispersant usage may improve coating performance. For example, lower total dispersant usage may facilitate lower haze coating due to minimizing unbound dispersants blooming to any air interface. In some embodiments, % haze of a coating made using the dispersion may be less than or equal to 15, 10, 5, 2, 1, 0.9, 0.8, 0.7, 0.6, 0.5, or even 0.4 percent. Existing coatings may require a greater total amount of dispersant to achieve the same % haze. Lower total dispersant usage may also facilitate higher abrasion resistance, for example, due to higher acrylic resin content and less non-bonded dispersants functioning as plasticizers. In some cases, lower total dispersant usage may facilitate better weatherability. Further, lower total dispersant usage may lower formulation viscosity, which may be beneficial in certain applications.

The compositions of the present disclosure may be used in any suitable applications, such as the making of a polymeric hardcoat having pigment particles or in coated or extruded layers, such as an adhesive layer, having pigment particles. In general, such compositions and hardcoats may be suitable for use in various applications, such as solar control in automotive or building window films, near infrared (NIR) camera-readable license plates and traffic signs, fiber laser protective films, among others.

Any suitable technique may be used for making a polymeric hardcoat with the compositions. In one example, a method of making a hardcoat with pigment particles includes one or more of the following: dissolving a curable binder material in a solvent to form a solution, adding the solution to a dispersion having any composition of the present disclosure, adding one or more additives to the dispersion, coating the dispersion onto a substrate, drying the coating to remove the solvent, and curing the dried coating.

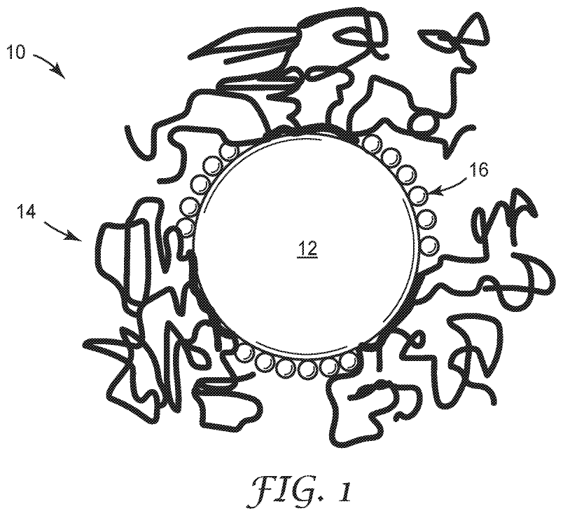

The composition may provide dispersed pigment particles. In some embodiments, each pigment particle may be anchored to at least one polymeric first dispersant molecule and at least one second dispersant molecule to form a plurality of dispersed pigment particles. FIG. 1 shows one example of a dispersed pigment particle 10. The dispersed pigment particle 10 includes a pigment particle 12 anchored to one or more first dispersants 14 and one or more second dispersants 16.

As used herein, an “anchoring group” or “anchor group” refers to a functional group on a molecule able to immobilize the molecule to the pigment particle.

In general, each dispersant may include at least one anchoring group that is a pigment affinic anchoring group for the pigment particle being used in the composition. Non-limiting examples of an anchoring group includes amine, ammonium salt, phosphate, sulfonate, sulfate, carboxylate, phosphonate, and phosphinate.

Anchoring groups of the dispersant may be categorized as cationic, anionic, or nonionic depending on their charge. The charge group may also be neutralized by a counter ion. Non-limiting examples of cationic anchoring groups include amines (or polyamines) or ammonium salts. Non-limiting examples of anionic anchoring groups include phosphates, sulfonates, and carboxylates. Non-limiting examples of nonionic anchoring groups include ether or esters.

As used herein, the term “charge” refers to partial charge on the non-carbon atom of the anchoring group such as N or O. These partial charges can be extracted from electron densities measured using high resolution x-ray or electron diffraction techniques. Spectroscopic measurement of core-electron binding energy shifts and dipole moment measurements also provide information on surface charge. When acidic, the charge of a dispersant may be referred to as an acid value. Acid values can be determined by conventional methods, such as titration.

In some embodiments, the first dispersant and the second dispersant each have an anchoring group. At least one anchoring group of the first dispersant may have a similar surface charge as at least one anchoring group of the second dispersant when disposed in the same solution.

As used herein, the term “similar surface charge” refers to a surface charge of the anchoring group of the first dispersant being the same or neutral as the surface charge of the anchoring group of the second dispersant. For example, the first dispersant may have a positive charge, and the second dispersant may have a positive or neutral charge.

Any suitable technique may be used to make the composition of the present disclosure. In one example, a method of making a pigment dispersion including the composition includes one or more of the following: dissolving a polymeric first dispersant and a second dispersant in a solvent to form a solution, mixing a plurality of pigment particles including a metal oxide into the solution to form a dispersion, and milling the dispersion to a desired particle size.

In some embodiments, the present disclosure provides a composition including a polymeric dispersant and a low molecular weight dispersant, which may also be described as a surfactant. Polymeric dispersants may be used to provide sufficient separation during high-impact milling process. Low molecular weight dispersants may be used to facilitate surface coverage complementary to the polymeric dispersant. The composition may provide improved surface stabilization and coverage of metal oxide nanoparticles, such as tungsten oxide nanoparticles, especially compared to compositions using only polymeric dispersants, for example, by allowing for reduced the total dispersant usage by weight.

Particles in such dispersions may be made via ceramic processes under reducing conditions (partial hydrogen pressure), so the primary crystal sizes are usually hundreds of nanometers or bigger. High energy media milling process may be applied to reach the desired particle size distributions for applications. For example, distributions in the sub-100 nanometer range are used in many optical applications, such as solar control window films, to have very low to no visible light scattering.

The composition may be provided in the form of a liquid dispersion or a solid dispersion. The liquid dispersion may include one or more solvents. The solid dispersion may be made by removing the all solvents in the liquid dispersion. The solid dispersion may be re-dispersed into liquid form by adding one or more solvents. Changing between liquid and solid dispersions may not significantly change dispersed pigment particle sizes.

As used herein, the term “pigment particle” refers to an insoluble particle added in order to change the transmission of solar energy through a material. The pigment particle may be inorganic or organic. In some embodiments, the pigment particles selectively scatter light in either in the visible or the infrared wavelength range, which may be described as nonwhite in color. In other embodiments, the pigment particles scatter light in both the visible and the infrared wavelength ranges, which may be described white, such as a titanium dioxide pigment particle.

As used herein, the term “dispersed pigment particle” refers to a pigment particle that has been anchored to one or more dispersants.

The pigment particles may include a metal oxide. In some embodiments, metal oxides may include tungsten oxide or mixed valent tungsten oxides. Metal oxides that are visible absorbing may be used, such as cerium oxide, zinc oxide, titanium oxide, tin oxide, manganese oxide, other transition metal oxides or metal oxide pigment nanoparticles (e.g., chromium-iron oxide, spinel oxides (e.g., cobalt aluminate), and iron manganese oxides). Metal oxides that are IR absorbing may also be used, such as antimony tin oxide (ATO), indium tin oxide (ITO), aluminum doped zinc oxide, and zinc antimony oxide.

Mixed valent tungsten oxides may include, for example, reduced tungsten oxides, such as tungsten blue oxides (TBO), such as WO_{2.92}, WO_{2.81}, and WO_{2.72}, or tungsten bronze oxides of the type MₓWO₃, where M can be sodium, potassium, cesium, or a host of other metals. Tungsten bronze oxides may be referred to as tungsten oxides or doped tungsten oxides, such as cesium tungsten oxide (CsWO) or potassium tungsten oxide (KWO). Mixed valent tungsten oxides in nanoparticle form generally allow high visible light transmission and low near infrared transmissions (or high near infrared absorption).

Dispersants may be used to stabilize particles in solid or liquid dispersions with incompatible solids or liquids. The particles, especially small particles with high surface areas, tend to aggregate, for example, in the absence of any other charge stabilizing mechanism. A dispersant may use a steric barrier, electrostatic charge, or electro-steric mechanism to prevent separate solid particles.

The first dispersant may be a polymeric dispersant, or polymer dispersing agent, which is a polymer in which various lipophilic functional groups and hydrophilic functional groups are attached to the ends of a polymer main chain. Some examples of functional groups of the polymeric first dispersants include a polyether, polyester, an acrylic, or a urethane.

As used herein, the term “polymeric” describes molecules having many repeating subunits. The term “nonpolymeric” describes molecules without many repeating subunits. For example, a polymeric molecule may have greater than or equal to 10, 20, 30, 50, 100, 200, or even 500 repeating subunits.

Polymeric first dispersants may be larger molecular weight oligomers or polymers. In some embodiments, the average or minimum molecular weight of the polymeric first dispersant is greater than or equal to 1500, 2000, 3000, 4000, 5000, or even 6000 amus.

In some embodiments, the polymeric first dispersants may have a backbone chain with a long length. In some embodiments, the backbone chain length may be greater than or equal to 15, 20, 25, or even 30 carbon-carbon or carbon-heteroatom bonds.

The polymeric first dispersant may include block copolymers, such as diblock, triblock, and brush, with acidic, basic, or nonionic binding groups. Generally, block copolymers are more effective than random copolymers. In some cases, random copolymers may be used and may be more effective.

In general, polymeric dispersants having multiple anchoring sites may provide better stability than dispersants having only one anchoring site. Polymeric dispersants may lower the incidence of the dispersant molecules migrating to the air interface. Polymeric dispersants may also provide better steric hinderance and a steric barrier for high energy media milling processes. Polymeric dispersants may be limited by the number of dispersants anchored to one particle due to steric hinderance, and multiple nanoparticles may be anchored to one dispersant particle in some cases.

The first dispersant particle anchoring site can be nonionic, anionic (usually carboxylic, phosphoric, or sulfonic), or cationic (usually amine derivatives). Non-limiting examples of anchoring groups of the first dispersant include polyethylene oxides (PEO), polypropylene oxides (PPO), polyethylene oxide—poly propylene oxide copolymers (PEO/PPO), polyurethane (PU), polycaprolactone, and polyacrylates.

In some embodiments, molecules of the first dispersant may include a polymer chain. Non-limiting examples of polymer chains include polyether, polyester, polyurethane, and polyacrylates.

In some embodiments, the molecules of the first dispersant may include copolymers in the polymer. Non-limiting examples of copolymers in the polymer chain include a polyester-polyamine copolymer, a polyester-phosphate copolymer, or both. For example, some suitable polyester-polyamine copolymers include SOLPLUS D510 and SOLPERSE M387 (each commercially available from Lubrizol Corporation, Wickliffe, OH).

The second dispersant may be a low molecular weight dispersant. Low molecular weight dispersants may also be described as small molecular weight surfactants. Such small molecular weight surfactants have been used to stabilize water-oil systems and nanoparticle synthesis. In some embodiments, the average or maximum molecular weight of the second dispersant is less than or equal to 2000, 1000, 750, 500, 400, 300, 200, or 150 amus.

In some embodiments, the second dispersant may be a nonpolymeric second dispersant. In other embodiments, the second dispersant may be polymeric and have a backbone chain with a short length. In one example, the second dispersant may have a maximum or average backbone chain length of less than or equal to 30, 25, 20, or even 15. In general, when both the first dispersant and the second dispersant are polymeric, the first dispersant has a longer average backbone chain length than the second dispersant.

Low molecular weight dispersants may be typical, well-defined molecules with a fixed formula weight. Low molecular weight dispersants may have well-defined anchoring groups, such as a positively charged quaternary ammonium ion or a negatively charged anionic group, like sulfate, sulfonate, phosphate, etc. A tail part of the dispersant may provide solubility in the solvent media. A low molecular weight may result in more anchoring groups (which may also be described as binding units or headgroups) per unit weight and hence higher surface coverage per unit weight of dispersant. Small molecules may also have better mobility and faster binding mechanism.

In some existing techniques, low molecular weight dispersants have not been found to be suitable for dispersing nanoparticles through grinding or ball milling approach. Low molecular weight dispersants typically do not have chain lengths long enough to form a protective shell to prevent particles contacting each other during vigorous milling environments.

In some embodiments, the second dispersant includes molecules having a cationic anchoring group. Cationic anchoring groups may include quaternary ammonium salts. Non-limiting examples of molecules having a cationic anchoring group include dodecyltrimethylammonium bromide (DTAB) and dimethyldioctadecylammonium bromide (DODAB), which are examples of quaternary ammonium salts.

In some embodiments, the second dispersant includes molecules having an anionic anchoring group. Non-limiting examples of molecules having an anionic anchoring group include sodium dodecyl sulfate, sodium dodecylbenzene sulfonate, and dihexadecyl hydrogen phosphate.

In some embodiments, the second dispersant includes molecules having a nonionic anchoring group. Non-limiting examples of molecules having a nonionic anchoring group include 2-(methylamino)ethanol (MAE), 3-dimethylamino-1-propanol (DMAP), and 2-[2-(dimethylamino)ethoxy]ethanol (DMAEE).

In general, when comparing the dispersants, the polymeric first dispersant may be described as having a higher molecular weight, a large steric barrier, some polymeric dispersants have multiple anchoring groups per molecule, which provide more stable average anchoring. The low molecular weight second dispersant may be described as having a lower molecular weight, a small steric barrier, few anchoring groups per molecule, and a less stable surface adsorption.

In general, use of the second dispersant may reduce the total amount of carbon and hydrogen used in dispersant particles compared to dispersions only using long backbone chain polymeric dispersants. In some embodiments, a weight of polymeric first dispersant is less than or equal to 50, 40, 30, 25, 20, 15, or even 10 percent of the weight of the pigment particle in the composition. In some embodiments, a combined weight of the polymeric first dispersant and the second dispersant is less than 60, 55, 50, 45, 40, 35, 30, 25, 20, or even 15 percent of the weight of the pigment particle.

Use of the second dispersant may reduce the amount of polymeric first dispersant needed to provide a similar milled particle size. In some embodiments, using the second dispersant may reduce the ratio between the total weight of dispersant to the weight of the pigment particles by at least 20, 30, 40, or even 50 percent when compared to using the polymeric first dispersant only while achieving similar average particle sizes.

As used herein, the term “similar average particle size” refers to one average particle size being within 50, 40, 30, 25, 20, 15, or 10 percent of one another average particle size.

As used herein, the terms “Z-Average size” and “average particle size” may be used interchangeably and refer to the harmonic intensity averaged hydrodynamic particle diameter in the cumulants analysis as defined in ISO 13321 and ISO 22412. The Z-Average size may be measured using any suitable instrument, such as the ZETASIZER NANO ZS (commercially available from Malvern Instruments Inc, Westborough, MA).

Suitable sizes of dispersed particles made of the composition may be determined based on the application. In some embodiments, particularly for optical applications, the plurality of dispersed pigment particles has an average particle size less than or equal to 250, 200, 150, 100, 75, or even 50 nanometers.

The pigment particles and dispersants may be mixed into a dispersion media or solvent to form a liquid dispersion. Non-limiting examples of dispersion media, or solvents, include water, organic alcohols or other alcohols, hydrocarbons or organic solvents, ketones, oils, monomers, oligomers, or any combination of these. In particular, the solvent may include 1-methoxy-2-propanol (MP), methyl ethyl ketone (or 2-butanone) (MEK), ethylene glycol (EG), or water. One example of an organic alcohol is MP.

In some embodiments, the selection of molecules for the first dispersant and the second dispersant may depend at least in part on their respective solubility in the solvent. The solubility of such dispersants in the solvent depend on their chemical structures.

In some embodiments, various dispersants may be used with water as the solvent. The first dispersant may include one or more of poly(ethylene oxide), poly(ethylene oxide)-poly(propylene oxide) copolymers, a dispersant commercially available from BYK Additives & Instruments of Wesel, Germany, such as ANTI-TERRA-250, BYK-154, BYK-156, DISPERBYK-183, DISPERBYK-184, DISPERBYK-185, DISPERBYK-191, DISPERBYK-192, DISPERBYK-199, DISPERBYK-2015, or DISPERBYK-2096, a dispersant commercially available from Lubrizol Corporation of Wickliffe, Ohio, such as SOLSPERSE W100, SOLSPERSE W200, SOLSPERSE W320, SOLSPERSE 43000, SOLSPERSE WV400, SOLSPERSE 43000, or SOLSPERSE 47000, a dispersant commercially available from Croda Industrial Chemicals of Edison, New Jersey, such as SPAN 20, SPAN 40, SPAN 60, SPAN 80, TWEEN 20, TWEEN 40, TWEEN 80, or a dispersant commercially available from Dow Chemical Company of Midland, Michigan, such as TRITON X-100. The second dispersant may include dodecyltrimethylammonium bromide (DTAB), cetyltrimethylammonium bromide, dimethyldioctadecylammonium bromide (DODAB), sodium dodecyl sulfate, sodium dodecylbenzene sulfonate, or dihexadecyl hydrogen phosphate.

In some embodiments, various dispersants may be used with a water-soluble polar organic solvent. The first dispersant may include one or more of a dispersant commercially available from BYK Additives & Instruments, such as DISPERBYK, DISPERBYK-180, DISPERBYK-182, DISPERBYK-2013, DISPERBYK-2055, DISPERBYK-2059, BYKJET-9151, or BYKJET-9152, or a dispersant commercially available from Lubrizol Corporation, SOLSPERE 20000, SOLSPERE 27000, SOLSPERE 45000, SOLSPERE 54000, SOLSPERE 65000, SOLSPERE 71000, SOLPLUS D540, SOLPLUS D545, or SOLPLUS D570. The second dispersant may include dodecyltrimethylammonium bromide (DTAB), cetyltrimethylammonium bromide, dimethyldioctadecylammonium bromide (DODAB), sodium dodecyl sulfate, sodium dodecylbenzene sulfonate, or dihexadecyl hydrogen phosphate.

In some embodiments, various dispersants may be used with less polar organic solvents, such as methyl ethyl ketone (MEK) and toluene. The first dispersants may include one or more of a dispersant commercially available from BYK Additives & Instruments, such as BYK-W903, BYK-W969, BYK-W985, BYK-W995, BYK-W996, BYK-W9010, BYK-W9011, BYK-W9012, DISPERBYK-111, DISPERBYK-118, BYK-9076, BYK-9077, DISPERBYK-163, DISPERBYK-168, DISPERBYK-184, DISPERBYK-2008, DISPERBYK-2152, DISPERBYK-2155, or a dispersant commercially available from Lubrizol Corporation, such as SOLSPERSE 32000, SOLSPERSE 36000, SOLSPERSE 39000, SOLSPERSE 41000, SOLSPERSE 71000, SOLSPERSE 75000, SOLSPERSE76500, SOLSPERSE85000, SOLSPERSE 88000, SOLSPERSE, SOLSPERSE M385, SOLSPERSE M387, SOLSPERSE M388, SOLSPERSE M387. The second dispersant may include 2-(methylamino)ethanol, 3-dimethylamino-1-propanol, or 2-[2-(dimethylamino)ethoxy]ethanol.

### EXAMPLES

Compositions of metal oxide dispersions with polymeric and nonpolymeric dispersants were made and tested for particle size. The dispersions were formulated into a coating solution, applied to a film, and dried. The haze and transmission of the dried coating was measured.

These examples are merely for illustrative purposes only and are not meant to be limiting on the scope of the appended claims. All parts, percentages, ratios, etc. in the examples and the rest of the specification are by weight, unless noted otherwise. The following abbreviations are used herein: nm=nanometer, g/m²=gram per meter squared, g=grams, ° C.=Centigrade.

### Materials

TABLE 1
Materials

| Abbreviation | Description | Source |
|---|---|---|
| CsWO | Particle, Cesium Tungstate, | Huben New Material |
| | HB-PT001 | Technology |
| | | Shanghai, China |
| KWO | Particle, Potassium Doped | PCT Pat. App. Pub. |
| | Tungstate | No. 2020/016755 A1 |
| | | (Sharma et al.) |
| | | Example 1, CE-B |
| MP | Solvent, 1-Methoxy-2-Propanol | Alfa Aesar |
| | | Haverhill, MA |
| MEK | Solvent, Methyl Ethyl Ketone | Alfa Aesar |
| | or 2-Butanone | |
| EG | Solvent, Ethylene Glycol or | Sigma-Aldrich |
| | 1,2-Ethanediol | St. Louis, MO |
| H₂O | Solvent, Deionized water | |
| D510 | Dispersant, SOLPLUS D510 | Lubrizol Corporation |
| | Polymeric Dispersant | Wickliffe, OH |
| D540 | Dispersant, SOLPLUS D540 | Lubrizol Corporation |
| | Polymeric Dispersant | |
| M387 | Dispersant, SOLSPERSE M387 | Lubrizol Corporation |
| | Polymeric Dispersant | |
| DTAB | Dispersant, | Sigma-Aldrich |
| | Dodecyltrimethylammonium | |
| | bromide | |
| DODAB | Dispersant, | Sigma-Aldrich |
| | Dimethyldioctadecylammonium | |
| | bromide | |
| SDS | Dispersant, Sodium dodecyl | Sigma-Aldrich |
| | sulfate | |
| SDBS | Dispersant, Sodium | Sigma-Aldrich |
| | dodecylbenzene sulfonate | |
| DHP | Dispersant, Dihexadecyl hydrogen | Sigma-Aldrich |
| | phosphate | |
| MAE | Amine, 2-(methylamino)ethanol | Sigma-Aldrich |
| DMAP | Amine, 3-dimethylamino-1- | Sigma-Aldrich |
| | propanol | |
| DMAEE | Amine, 2-[2- | Sigma-Aldrich |
| | (dimethylamino)ethoxy]ethanol | |
| SR238 | hexanediol diacrylate monomer | Sartomer Company |
| | | Exton, PA |
| SR295 | pentaerythritol triacrylate | Sartomer Company |
| | monomer | |
| IRGACURE | photoinitiator | BASF Corporation, |
| 819 | | Florham Park, NJ |
| IRGACURE | photoinitiator | BASF Corporation |
| 184 | | |
| TEGORAD | slip agent | Evonik North America |
| 2250 | | Parsippany, NJ |
| PZ-33 | polyaziridine crosslinker | PolyAziridine LLC |
| | | Palm Beach, FL |

### Test Methods

### Particle Size

The particle size distributions were measured using Zetasizer Nano ZS (Malvern Instruments Inc, Westborough, MA). The detection angle of 1730 backscattering mode was used. The measure duration was set at the automatic mode which allowed software to determine the required duration time per run and number of runs needed. The measurement position and attenuation were also set at the automatic mode. “General Purpose (normal resolution)” model was selected as the software analysis model. Mark-Houwink A Parameter was set as 0.428 and K Parameter was set as 7.67e-05 cm²/s. The measurement temperature was set at 25° C. The solvent viscosity used was 0.43 centipoise for MEK. The solvent viscosity was used as the sample viscosity due to the low particle concentration. The samples were first diluted with the same solvent used in milling to 1:100 to 1:10000 by volume. The Z-Average particle size data were reported based on dynamic light scattering theory. The Z-Average size is the harmonic intensity averaged hydrodynamic particle diameter in the cumulants analysis as defined in ISO 13321 and ISO 22412. The size distribution was calculated from a 2-parameter fit to the correlation data as defined in the ISO standard document 13321:1996 E or ISO 22412:2008.

### Haze and Transmission

Transmission and haze readings were taken on a BYK haze-gard plus (BYK Instruments USA, Columbia, MD).

### Coating Thickness

Thickness of coatings was measured using a tec5 AG UV-VIS spectrometer (tec5 USA Inc, Plainview, NY) using an assumed refractive index of 1.49.

### EXAMPLES—DISPERSIONS

The dispersions were processed using media milling process. Dispersants and solvents were first mixed until fully dissolved, and then the pigment powder was slowly charged in. The mixed dispersion was milled in MiniCer (NMC) or LabStar (NLS) laboratory media mill (Netzsch, Exton PA) with 0.2 millimeter Toraycerum yttria stabilized zirconia milling media. Small amounts of samples were taken out periodically to monitor the milling progress through particle size measurement. Table 2 shows the dispersant formulations (% and ratios calculated for each Example), mill type, milling time and resulting particle size.

### Examples E1-E5, CE1-CE2: CsWO/MP/H2O/First Dispersant D510/Second Dispersant DTAB

E1-E2: The nanoparticle dispersion E1 was made using total 55% dispersant to particle (D1/P=50, D2/P=5). The dispersion E2 was made of total 35% dispersant to particle (D1/P=25%, D2/P=10%).

CE1a, CE1b, E3: 1) The CE1a dispersion formulated with only the second dispersant and without the first dispersant. The CE1a dispersion was milled for 2 hours to reach submicron particle size but did not get enough size reduction. 2) The CE1b dispersion was made by adding 10% of the first dispersant (D1/P=10%) to E3. The CE1b dispersion was milled for another 2 hours to get further size reduction to less than 400 nm. 3) The E3 dispersion was made by adding another 10% of the first dispersant to CE1b to reach total 35% of dispersant (D1/P=20%, D2/P=15%). The E3 dispersion was milled for another 2 hours and reduced the particle size to less than 100 nm.

E4: A higher pigment concentration formulation (27% of the final dispersion) was milled using Labstar mill to support formulation evaluation in the precision pilot coater. The final dispersion was composed of 35% dispersant to particle (D1/P=30%, D2/P=5%).

CE2: The CsWO/MP dispersion was made using only the first dispersant and it required around 100% of the first dispersant to particle (D1/P=100%) to reach desired particle sizes without the second dispersant.

E5: The CsWO/MP dispersion was made of the same first dispersant as E1-E4 and CE1a-CE1b but replaced the second dispersant from DTAB to DODAB (dimethyldioctadecylammonium bromide). DODAB is a double-chained quaternary ammonium molecular. Total 60% of dispersant to particle (D1/P=50%, D2/P=10%) was used to reach less than 200 nm particle size.

### Examples E6-E7, CE3: KWO/MP/First Dispersant D510/Second Dispersant DTAB

E6: The dispersion was made using 45% of total dispersants to particle ratio (D1/P=40%, D2/P=5%).

E7: The dispersion was similar to E6 with 46% of total dispersants to particle ratio but was milled for extended time to reduce the particle sizes to less than 50 nm.

CE3: This comparative example used only the first dispersant and required around 100% of the dispersant to particle ratio (D1/P) to reach the desired particle sizes without the use of the second dispersant.

### Examples E8, CE4: CsWO/MEK/First Dispersant M387/Second Dispersant MAE

E8: The second dispersant (MAE) was used to minimize the first dispersant usage. Total 55% dispersant to particle (D1/P=50%, D2/P=5%) were used.

CE4: 100% of the first dispersant to particle (D1/P) was used.

### Examples E9-E11, CE5: KWO/MEK/First Dispersant M387/Second Dispersants

E9-11: Three KWO/MEK dispersions were made by three different second dispersants, including MAE for E9, DMAP for E10, and DMAEE for E11. All of them used the same first dispersant. 50% of the first dispersant to particle ((D1/P=50%) and 5% of the second dispersant to particle (D2/P=5%) were used.

CE5: 100% of the first dispersant to particle (D1/P) was used.

### Examples E12-E13: CsWO/EG/First Dispersant D540/Second Dispersant

E12: The dispersion used SDS as the second dispersant. It was composed of total 50% of dispersants to particle (D1/P=40%, D2/P=10%).

E13: The dispersant used DHP and DS-10 as the second dispersants. It was composed of total 70% dispersant to particle (D1/P=50%, D2/P=10%).

TABLE 2
Dispersion formulations, mill used for the experiment, and milling time

| | | | | | | | Milling |
|---|---|---|---|---|---|---|---|
| | Pigment | Dispersant 1 | Dispersant 2 | Solvent 1 | Solvent 2 | | Time |
| Example # | (P) | (D1) | (D2) | (S1) | (S2) | Mill | (hours) |
| E1 | CsWO | D510 | DTAB | MP | H2O | NMC | 6 |
| E2 | CsWO | D510 | DTAB | MP | H2O | NMC | 5 |
| CE1a | CsWO | — | DTAB | MP | H2O | NMC | 2 |
| CE1b | CsWO | D510 | DTAB | MP | H2O | NMC | 4 |
| E3 | CsWO | D510 | DTAB | MP | H2O | NMC | 6 |
| E4 | CsWO | D510 | DTAB | MP | — | NLS | 3 |
| E5 | CsWO | D510 | DODAB | MP | H2O | NMC | 4 |
| CE2 | CsWO | D510 | — | MP | — | NLS | 5 |
| E6 | KWO | D510 | DTAB | MP | — | NLS | 5 |
| E7 | KWO | D510 | DTAB | MP | — | NMC | 10 |
| CE3 | KWO | D510 | — | MP | — | NLS | 5 |
| E8 | CsWO | M387 | MAE | MEK | — | NMC | 2 |
| CE4 | CsWO | M387 | — | MEK | — | NMC | 11 |
| E9 | KWO | M387 | MAE | MEK | — | NMC | 6 |
| E10 | KWO | M387 | DMAP | MEK | — | NMC | 6 |
| E11 | KWO | M387 | DMAEE | MEK | — | NMC | 6 |
| CE5 | KWO | M387 | — | MEK | — | NMC | 5 |
| E12 | CsWO | D540 | SDS | EG | H2O | NMC | 5 |
| E13 | CsWO | D540 | DHP/DS-10 | EG | H2O | NMC | 7 |

TABLE 3
Dispersion formulations (percentage % and ratios calculated
for each Example) and resulting particle size

| | P | D1 | D2 | S1 | S2 | D1/P | D2/P | D/P | Particle Size |
|---|---|---|---|---|---|---|---|---|---|
| Example # | % | % | % | % | % | % | % | % | (nm) |
| E1 | 8.3 | 4.2 | 0.4 | 83.0 | 4.2 | 50 | 5 | 55 | 42 |
| E2 | 8.4 | 2.1 | 0.8 | 84.4 | 4.2 | 25 | 10 | 35 | 55 |
| CE1a | 9.4 | 0 | 1.4 | 84.5 | 4.7 | 0 | 15 | 15 | 986 |
| CE1b | 9.3 | 0.9 | 1.4 | 83.7 | 4.7 | 10 | 15 | 25 | 329 |
| E3 | 9.2 | 1.8 | 1.4 | 83.0 | 4.6 | 20 | 15 | 35 | 60 |
| E4 | 27.1 | 8.1 | 1.4 | 63.4 | — | 30 | 5 | 35 | 57 |
| E5 | 9.0 | 4.5 | 0.9 | 81.1 | 4.5 | 50 | 10 | 60 | 148 |
| CE2 | 23.1 | 23.1 | — | 53.9 | — | 100 | — | 100 | 59 |
| E6 | 26.4 | 10.6 | 1.3 | 61.7 | — | 40 | 5 | 45 | 73 |
| E7 | 27.3 | 11.1 | 1.4 | 60.2 | — | 41 | 5.1 | 46 | 47 |
| CE3 | 23.1 | 23.1 | — | 53.9 | — | 100 | — | 100 | 96 |
| E8 | 22.0 | 11.0 | 1.1 | 65.9 | — | 50 | 5 | 55 | 136 |
| CE4 | 18.1 | 18.1 | — | 63.8 | — | 100 | — | 100 | 114 |
| E9 | 16.9 | 8.4 | 0.8 | 73.9 | — | 50 | 5 | 55 | 393 |
| E10 | 25.0 | 12.5 | 1.3 | 61.2 | — | 50 | 5 | 55 | 237 |
| E11 | 20.0 | 10.0 | 1.0 | 68.9 | — | 50 | 5 | 55 | 179 |
| CE5 | 23.2 | 23.2 | — | 53.7 | — | 100 | — | 100 | 88 |
| E12 | 9.1 | 3.6 | 0.9 | 81.8 | 4.6 | 40 | 10 | 50 | 199 |
| E13 | 8.9 | 4.5 | 0.9/0.9 | 80.4 | 4.5 | 50 | 20 | 70 | 272 |

### Examples—Hardcoat with E4, E6, CE2, CE3 Dispersions

The hardcoat coating solutions included acrylate monomers blended with the pigment dispersion, photoinitiators sensitive to UV light, a crosslinking agent, and a slip agent. These solutions were coated onto a PET film, dried and cured. See Table 4 for formulations. Hardcoat solutions were created in two steps. First, a premix solution was made by mixing equal parts SR238 monomer, SR295 monomer, and MEK solvent together, then adding PZ33 crosslinker at 5.8% of acrylate weight, TEGORAD 2250 slip agent at 0.67% of acrylate weight, and photoinitiators IRGACURE 184 and IRGACURE 819 at 2.4% of acrylate weight each. This monomer premix was then slowly added to the pigment dispersion (E4, E6, CE2 or CE3) under constant mixing to the weight ratios shown in Table 4 below. A solvent blend of 50% MEK and 50% MP was also added as shown in Table 4 to facilitate mixing. The solutions were mixed for an additional hour after that.

The hardcoat coating solutions were coated onto a 50 micron thick, clear PET film with a precision extrusion die supplied using a pressurized vessel controlled via a mass flowmeter. The PET had a measured transmission of 93% and a bulk haze of 0.6%. Bulk haze and transmission of the PET was measured by applying a clear liquid with a low enough surface tension to form a continuous layer on both sides of the film before measuring haze. In this case, 1-methoxy-2-propanol was the liquid used. The coatings were dried at an average temperature of 65° C. for 1 minute, then cured in a 600-Watt, Model I603M UV Cure Chamber (Fusion UV Systems, Gaithersburg MD) under nitrogen purging at 100% power for 5 seconds. The dispersion pigment loading was calculated. The dry coated thickness, transmission and haze were measured and reported in Table 5.

TABLE 4
Hardcoat Formulations with E4, E6, CE2 and CE3 Dispersions

| Hardcoat | | Wt % | Wt % Monomer | Wt % Solvent |
|---|---|---|---|---|
| Formulation | Dispersion | Dispersion | Premix | Blend |
| E14 | E4 | 28.5% | 69% | 2.5% |
| CE6 | CE2 | 38.5% | 58.5% | 3% |
| CE7 | CE2 | 47.5% | 49% | 3.5% |
| E15 | E6 | 27.5% | 66% | 6.5% |
| CE8 | CE3 | 37% | 60% | 3% |
| CE9 | CE3 | 23% | 75% | 2% |

TABLE 5
Transmission and Haze Results for Hardcoats
Using Formulations of Table 4

| | | Hardcoat | | | |
|---|---|---|---|---|---|
| | | Pigment | Hardcoat | | |
| Hardcoat | Hardcoat | Loading | Thickness | % | % |
| Example | Formulation | (g/m²) | (micrometer) | Transmission | Haze |
| E16 | E14 | 1.96 | 5.8 | 75 | 0.5 |
| E17 | E14 | 2.45 | 7.5 | 69.8 | 0.6 |
| CE10 | CE6 | 1.67 | 5.8 | 76.9 | 0.4 |
| CE11 | CE6 | 2.08 | 7.4 | 72.2 | 0.5 |
| CE12 | CE7 | 1.80 | 5.5 | 74.5 | 0.6 |
| CE13 | CE7 | 2.26 | 6.9 | 69.9 | 0.8 |
| E18 | E15 | 0.99 | 3.0 | 75.3 | 0.4 |
| E19 | E15 | 1.17 | 3.6 | 72.6 | 0.4 |
| CE14 | CE8 | 0.90 | 3.6 | 75.1 | 0.4 |
| CE15 | CE8 | 1.07 | 4.4 | 71.1 | 0.5 |
| CE16 | CE9 | 0.93 | 6.2 | 73.9 | 0.5 |
| CE17 | CE9 | 1.13 | 7.9 | 69.8 | 0.5 |

Thus, various embodiments of multidispersant metal oxide nanoparticle dispersion compositions are disclosed. Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety for all purposes, except to the extent any aspect directly contradicts this disclosure.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The term “or” is generally employed in its inclusive sense, for example, to mean “and/or” unless the context clearly dictates otherwise. The term “and/or” means one or all of the listed elements or a combination of at least two of the listed elements.

1. A composition comprising:
a plurality of pigment particles comprising a metal oxide;
a polymeric first dispersant comprising molecules having an average molecular weight greater than or equal to 2000 atomic mass units; and
a second dispersant comprising molecules having a maximum molecular weight less than 2000 atomic mass units.

2. The composition of claim 1, wherein the second dispersant comprises a nonpolymeric second dispersant.

3. The composition of claim 1, wherein the pigment particle comprises a mixed valent tungsten oxide.

4. The composition of claim 1, wherein the pigment particle comprises cesium tungsten oxide, potassium tungsten oxide, or any combination of these.

5. The composition of claim 1, wherein the molecules of the second dispersant comprise a polymer having maximum backbone chain length less than or equal to 20.

6. The composition of claim 1, wherein a weight of the polymeric first dispersant is less than 50% of the weight of the pigment particle in the composition, wherein the plurality of pigment particles comprises a mixed valent tungsten oxide.

7. The composition of claim 1, wherein a combined weight of the polymeric first dispersant and the second dispersant is less than 50% of the weight of the pigment particle in the composition, wherein the plurality of pigment particles comprises a mixed valent tungsten oxide.

8. The composition of claim 1, wherein each pigment particle of the plurality of pigment particles is anchored to at least one polymeric first dispersant molecule and at least one second dispersant molecule to form a plurality of dispersed pigment particles.

9. The composition of claim 8, wherein the plurality of dispersed pigment particles has an average particle size less than or equal to 250 nanometers.

10. The composition of claim 1, wherein an anchoring group of the first dispersant has a similar surface charge as an anchoring group of the second dispersant.

11. The composition of claim 10, wherein the molecules of the first dispersant comprise an anchoring group comprising amine, ammonium salt, phosphate, sulfonate, sulfate, carboxylate, phosphonate, and phosphinate.

12. The composition of claim 1, wherein the molecules of the second dispersant comprise a cationic anchoring group.

13. The composition of claim 12, wherein the molecules of the second dispersant comprise dodecyltrimethylammonium bromide (DTAB), dimethyldioctadecylammonium bromide (DODAB), or both.

14. The composition of claim 1, wherein the molecules of the second dispersant comprise an anionic anchoring group.

15. The composition of claim 1, wherein the molecules of the second dispersant comprise a nonionic anchoring group.

16. The composition of claim 1, further comprising a solvent to form a liquid dispersion.

17. The composition of claim 16, wherein the molecules of the first dispersant comprise a polyester-polyamine copolymer, the molecules of the second dispersant comprise a quaternary ammonium salt, and the solvent comprises 1-methoxy-2-propanol or 1-methoxy propan-2-ol (MP).

18. A hardcoat comprising the composition of claim 1.

19. A method of making a pigment dispersion, the method comprising:
dissolving a polymeric first dispersant and a second dispersant in a solvent to form a solution, wherein the first dispersant comprises molecules having an average molecular weight greater than or equal to 2000 atomic mass units, and wherein the second dispersant comprises molecules having a maximum molecular weight less than 2000 atomic mass units;
mixing a plurality of pigment particles comprising a metal oxide into the solution to form a dispersion; and
milling the dispersion to a desired particle size.

20. A method of making a hardcoat with pigment particles, the method comprising:
dissolving a curable binder material in a solvent to form a solution;
adding the solution to a dispersion including the composition according to claim 1;
adding one or more additives to the dispersion;
coating the dispersion onto a substrate;
drying the coating to remove the solvent; and
curing the dried coating.
